(19) United States
(12) Patent Application Publication
(10) Pub. No.: US 2016/0182961 A1
(43) Pub. Date: Jun. 23, 2016

(54) NETWORK MOVIE INSTANT MERCHANDISE PURCHASE SYSTEM AND METHOD

(71) Applicant: TAIWAN WEI-SHI VALUE TECH INC., TAIPEI CITY (TW)

(72) Inventor: Menq Der Cheng, Taipei City (TW)

(21) Appl. No.: 14/640,448

(22) Filed: Mar. 6, 2015

(30) Foreign Application Priority Data
Dec. 19, 2014 (TW) 103144502

(51) Int. Cl. H04N 21/478; H04N 21/81; H04N 21/8545; H04N 21/235

(52) U.S. Cl. CPC H04N 21/47815; H04N 21/2353; H04N 21/812; H04N 21/8545

(57) ABSTRACT

A network movie instant merchandise purchase system and method have a network server containing activity data base and a movie player to play the network movie. When the user clicks the merchandise shown on a played picture of the network movie, the movie player transmits a movie code, a time label and clicked coordinates corresponding to the played picture to the network server available for the network server to compare with the activity data of the activity data base, and when the activity data at a preset interval before and after the time label of the network movie directed by the movie code have a marking area containing the clicked coordinates, merchandise data in the merchandise data field of the activity data is included in an activity listing. Hence, the user is able to instantly click the merchandises shown on the played picture of the movie during watching the movie such that the desire of the user for acquiring the merchandise immediately can be satisfied and the vender can have opportunities for instant sales.

### CROSS-REFERENCE TO RELATED APPLICATIONS

The application claims priority from Taiwan Patent Application No. 103144502 filed on Dec. 19, 2014, the disclosure of which is incorporated herein by reference.

### BACKGROUND OF THE INVENTION

1. Field of the Invention

The present invention is related to a network service system and method, and particularly to a network movie instant merchandise purchase system and method.

2. Brief Description of the Related Art

Since image recording and playing technology maturely developed, watching movie has become one of our important entertainment activities, and many movie stars, merchandises or shooting scenes have emerged along with the entertainment activities getting popular.

According to past experiences, when there is a favorite movie focused by people, it is unavoidable that the starstrucks may follow the air of trend a while to wear apparels and ornaments worn by the stars, to imitate consuming behaviors done by the stars in the movie, or to go to the site of the shooting scene personally to aftertaste the movie, and etc. Under the circumstances, venders, who rush to sell their merchandises, do their best to make good relationships with the movie production unit to conduct embedding marketing such as offering them the promoted merchandises or advertising places.

However, during watching the conventional movie, it is known that the movie supplier simply provides the motion pictures, the viewer only watches the movie, and there are no chances for the viewer to interact with the movie. As a result, the apparels or the ornaments, which the viewer loves very much, are impossible to be owned immediately unless to purchase their loved items at online stores or physical stores afterward. Further, it is unable for the viewer to inquire the detail information concerning interesting shooting scenes shown in the movie immediately. Hence, it is a pity that watching the conventional movie is incapable of not only satisfying intentions of people for immediate acquirement but also having opportunities for the venders to conduct instant sales.

### SUMMARY OF THE INVENTION

Accordingly, an object of the present invention is to provide a network movie instant merchandise purchase system and method with which merchandises shown on played pictures can be clicked during the movie being watched to conduct purchasing the merchandises so as to satisfy intention of a user for acquiring the merchandises and offer the venders an opportunity for instant sales.

Another object of the invention is to provide a network movie instant merchandise purchase system and method with which scenes shown on played pictures can be clicked during the movie being watched such that detail information of the scenes can be further understood to satisfy desire of the user for coming on site and offer the venders an opportunity for instant sales.

In order to achieve the preceding object, the network movie instant merchandise purchase system according to the present invention is suitable for a user to instantly purchase merchandise shown on a network movie during watching the network movie, and the system comprises a network server and a movie player.

The network server has an activity data base which contains multiple activity data, each of the activity data including a movie code field, a time label field, a marking area field, and a merchandise data field, the movie code field having a movie code directing to said network movie, the time label field having a time label directing to an image picture on a timeline provided by the network movie, the marking area field having a marking area standing for a merchandise location shown on the image picture directed by the time label of the network movie, and the merchandise data field being data related to the merchandise shown in the marking area of the image picture directed by the time label of the network movie. The movie player is connected to the network server via such as an internet to play the network movie for being watched by the user.

Wherein, when the user clicks the merchandise shown on a played picture of the network movie, the movie player transmits a movie code, a time label and clicked coordinates corresponding to the played picture to the network server available for the network server to compare with the activity data of the activity data base, and when the activity data at a preset time interval before and after the time label of the network movie directed by the movie code contain a marking area with the clicked coordinates, merchandise data in the merchandise data field of the activity data is included in an activity listing for the user being able to inquire or confirm purchase.

In a preferred embodiment, the network server of the network movie instant merchandise purchase system transmits the aforementioned merchandise data to the movie player so as to allow the movie player to include the merchandise data in the activity listing and offer the user to inquire or confirm purchase.

In a preferred embodiment, the network server of the network movie instant merchandise purchase system has part of the activity data in the activity data base thereof includes the movie code field, the time label field, the marking area field, and an advertisement data field; the advertisement data field is advertisement data related to a scene shown on the marking area of the image picture directed by the time label of the network movie.

In a preferred embodiment, the preset time interval of the network movie instant merchandise purchase system is 0.6 second before and after the time label of the network movie directed by the movie code.

A network movie instant merchandise purchase method according to the present invention is suitable for a network server to provide a user to instantly purchase merchandise shown on a network movie during watching the network movie, the network server has an activity data base which contains multiple activity data with each of the activity data including a movie code field, a time label field, a marking area field, and a merchandise data field, the movie code field having a movie code directing to the network movie, the time label field having a time label directing to an image picture on a timeline provided by the network movie, the marking area field having a marking area standing for a merchandise location shown on the image picture directed by the time label of the network movie, and the merchandise data field being data related to the merchandise shown in the marking area of the image picture directed by the time label of the network movie; the method comprises following steps: receiving a movie code, a time label, and clicked coordinates at the time of the user clicking the merchandise shown on a played picture of the network movie; comparing the movie code, time label and clicked coordinates to the activity data of the activity data base; transmitting merchandise data in the merchandise data field of the activity data to be included in an activity listing at the time of the activity data at a preset interval before and after the time label of the network movie directed by the movie code having the marking area which contains the clicked coordinates.

Wherein, the network movie instant merchandise purchase method further comprises a step of available for the user to inquire or rearrange said activity listing.

Wherein, part of the activity data contained in the activity data base of the network server recited in the network movie instant merchandise purchase method includes a movie code field, a time label field, a marking area field, and an advertisement data field; the advertisement data field is data related to a scene shown on the marking area of the image picture directed by the time label of the network movie.

Wherein, the preset time interval recited in the network movie instant merchandise purchase method is 0.6 second before and after the time label of the network movie directed by the movie code.

The present invention further provides a method for setting up merchandises in a network movie suitable for setting up an activity data base required by the network movie instant merchandise purchase, the activity data base containing multiple activity data, each of the activity data including a movie code field, a time label field, a marking area field, and a merchandise data field; the method for setting up merchandises in a network movie comprises following steps: capturing an image on a played picture of the network movie; capturing a merchandise image; comparing if the merchandise image is on the played picture; recording the movie code of the network movie, the time label at the played picture in the network movie, marking area of the merchandise on the played picture, and the data related to the merchandise represented by the merchandise image to the movie code field, the time label field, the marking area field, and the merchandise data field of the activity data base respectively at the time of the merchandise image being on the captured played picture.

Wherein, the merchandise image is determined to be on the captured played picture if at least part of the features of the merchandise image is resided in the played picture with the proportional value is greater than a default proportional value.

Wherein, the default proportional value recited in the method for setting up merchandises in a network movie is 25%.

Wherein, the marking area recited in the method for setting up merchandises in a network movie is a rectangular marking block formed by upper left coordinates, horizontal width and vertical height at the position of the captured image of the merchandise shown on the played picture.

Wherein, the data related to the merchandise represented by the image of the merchandise recited in the method for setting up merchandises in a network movie includes merchandise names, merchandise thumbnail URL, and merchandise descriptive URL.

The present invention further provides a method for setting up advertisement in a network movie suitable for setting up an activity data base in accordance with operation of a user, the activity data base containing multiple activity data, each of the activity data including a movie code field, a time label field, a marking area field, and a advertisement data field; the method for setting up advertisement in a network movie comprises following steps: playing the network movie; capturing an advertisement activity data which is assigned by the user at the time of receiving the user requesting to pause the movie play and choosing to continue to play; repeating following steps at the time of not receiving the user requesting to pause the movie play: capturing the time label at which the played picture of said network movie is and a marking area assigned by the user, recording the movie code of said network movie, the time label at which the played picture of the network movie is, the marking area, and the data related to the advertisement activity to the movie code field, the time label field, the marking area field and the advertisement data field.

The preset time recited in the method for setting up advertisement in a network movie is 1 second.

In summary, a network movie instant merchandise purchase system and method in accordance with the present invention allow the user to click the merchandises or scenes shown on the played picture of the movie at the time of the movie being watched so as to instantly purchase the merchandises or understand detail information of the interested scenes such that the desire of the user for acquiring the merchandise immediately can be satisfied and opportunities of instant selling can be offer to the venders.

### BRIEF DESCRIPTION OF THE DRAWINGS

The detail structure, the applied principle, the function and the effectiveness of the present invention can be more fully understood with reference to following description and accompanying drawings, in which:

FIG. 1 is a block diagram illustrating a preferred embodiment of a network movie instant merchandise purchase system according to the present invention;

FIG. 2 is a flow chart illustrating a method for setting up merchandises with the network movie according to the preferred embodiment of the present invention;

FIG. 3 is a flow chart illustrating a method for setting up advisement with the network movie according to the preferred embodiment of the present invention;

FIG. 4 is a flow chart illustrating service procedure of the movie player provided in the network movie instant merchandise purchase system shown in FIG. 1;

FIG. 5 is a flow chart illustrating service procedure of the network server provided in the network movie merchandise purchase system shown in FIG. 1.

### DETAILED DESCRIPTION OF THE INVENTION

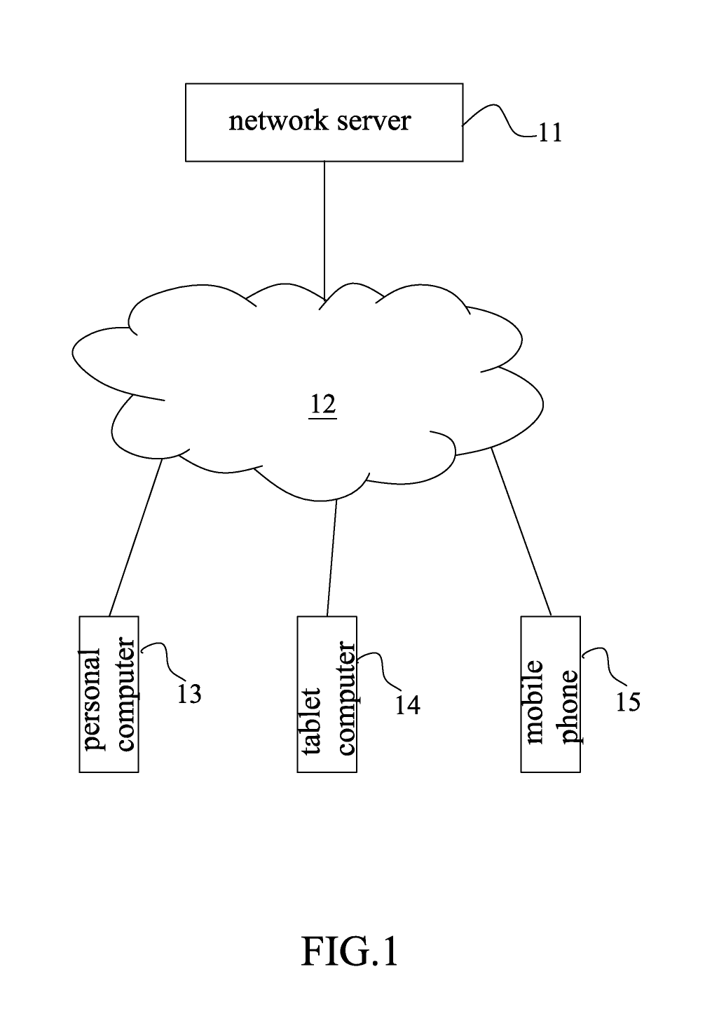

Referring to FIG. 1, the preferred embodiment of a network movie instant merchandise purchase system according to the present invention is illustrated. The network movie instant merchandise purchase system includes a network server 11 with an activity data base therein, and a movie player such as a personal computer 13, a tablet computer 14, or a mobile phone 15 which is connected to the network server 11 via the internet 12 to play a network movie for being watched by users.

Wherein, the activity data base in the network server 11 provides multiple activity data; each of the activity data includes a movie code field, a time label field, a marking area field, and a merchandise data field; the movie code in the movie code field directs to a watched network movie, the time label in the time label field directs to an image picture on timeline of the network movie, the marking area of the marking area field stands for a merchandise location shown on the image picture directed by the time label of the network movie, and the merchandise data field is data related to the merchandise shown in the marking area of the image picture directed by the time label of the network movie.

Besides, part of the activity data contained in the activity data base of the network server 11 may include the movie code field, the time label field, the marking area field, and an advertisement data field; the advertisement data field is advertisement data related to a scene shown on the marking area of the image picture directed by the time label of the network movie; that is, the merchandise data field and the advertisement data field constitute an activity data field in the activity data base to contain the merchandise data or the advertisement data.

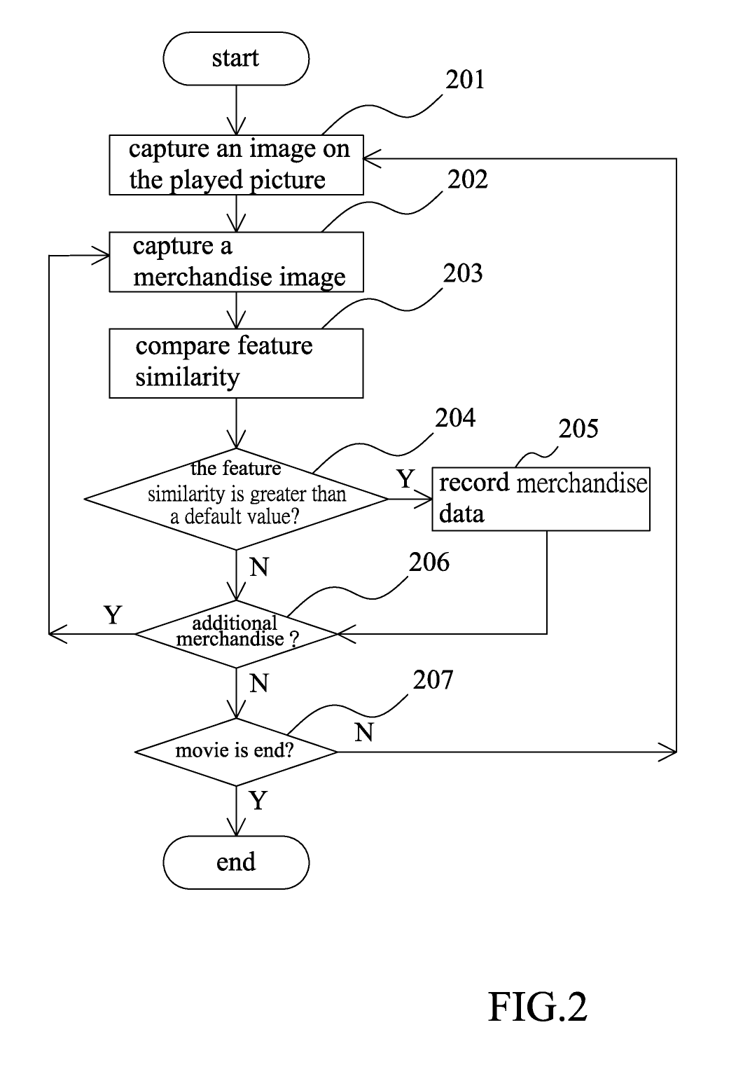

Referring to FIG. 2, a process related to a method for setting up merchandises in the network movie according to the preferred embodiment of the present invention is illustrated. The process is employed to set up activity data related to merchandises in the activity data base of the network server 11.

In the figure, the first step 201 is to capture an image on the played picture of the network movie; next, step 202 is to capture a merchandise image; then, step 203 is to compare feature similarity between the merchandise image and the image on the played picture of the network movie, and step 204 is to judge if the feature similarity is greater than a default value, that is, a proportional value of the feature of the merchandise image shown on the played picture being greater than a default proportional value such as 25% is taken to determine if the merchandise image is on the captured played picture.

When it is judged in step 204 that the merchandise image is on the captured played picture, step 205 is entered to record a movie code of the network movie, a time label at the played picture in the network movie, a marking area of the merchandise on the played picture, and data related to the merchandise represented by the merchandise image to the movie code field, the time label field, the marking area field, and the merchandise data field of the activity data base respectively.

When it is judged in step 204 that the merchandise image is not on the captured played picture, step 206 is entered to determine whether there is additional merchandise needed to compare or not. If there is additional merchandise needed to compare, it is to return to step 202 to capture the merchandise image of the merchandise to be compared and to execute the process of comparing and recording the merchandise data. If there is no additional merchandise needed to compare, step 207 is entered to judge if the movie is end. If the movie is not end yet, it is to return to step 201 to capture the image on the played picture of network movie and judge if the image of another played picture has any merchandise available for being purchased immediately so as to set up the instant merchandise purchase data of the played picture of the network movie.

Wherein, the marking area which the merchandise image is shown on the played picture can be rectangular shape block formed by upper left coordinates, horizontal width and vertical height at the captured image of the merchandise shown on the played picture, or any other regular or irregular shape block. The recorded data related to the merchandise represented by the image of the merchandise can include merchandise name, merchandise thumbnail URL, and merchandise descriptive URL which are available for being referenced by users to determine whether the merchandise is purchased or not.

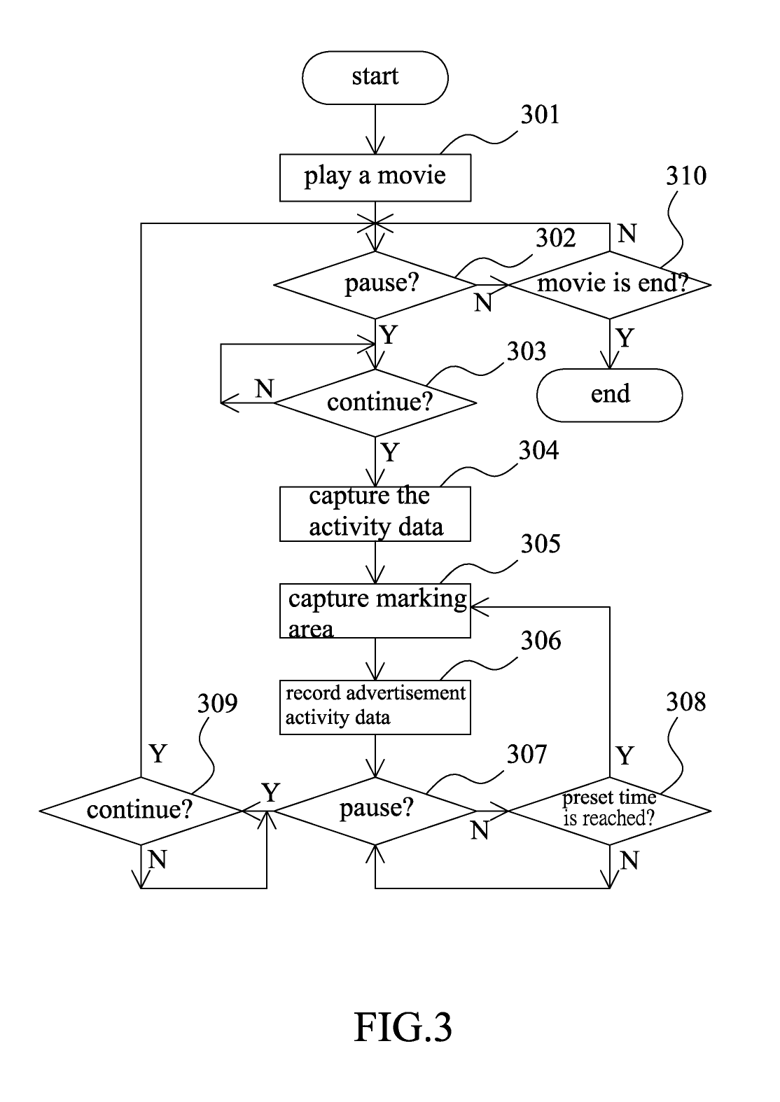

Referring to FIG. 3, the process of a method for setting up advertisement in the network movie according to the preferred embodiment of the present invention is illustrated. The process is employed to set up the advisement activity data related to such as the scene of the movie in the activity data base of the network server 11.

In the figure, the first step 301 is to play a movie; then, step 302 is entered to judge whether a user instructs to pause the played movie or not? If there is no instruction done by the user to pause the movie, step 310 is entered to determine whether the movie is end or not? If the movie is not end yet, the movie continues to play till the end. If there is an instruction done by the user to pause the played movie in step 302, it represents that the user has found an advertisement scene in the image and intended to set up the advertisement data in the activity data base for being checked out at the time of the movie being watched. Of course, persons familiar to the art know that the method for setting up the activity data with the advertisement scene manually is suitable for setting up the merchandise data of the activity data base as well.

In step 302, when it is determined that the user has instructed to pause the movie play, step 303 is entered to continue the movie play after the user keys in data to be set up as activity data with respect to the advertisement activity. After the user instructs to continue the movie play, step 304 is entered to capture the advertisement activity data keyed-in by the user, step 305 is entered to capture the time label on the played picture of the network movie and the marking area assigned by the user, and step 306 is entered to record the movie code of the network movie, the time label on the played picture of the network movie, the marking area and the data related to the advertisement activity to the movie code field, the time label field, the marking area field and the advertisement data field in the activity data base.

Afterwards, step 307 is entered to judge if the user instructs to pause the played movie again? When no instruction is done by the user to pause the played movie again, step 308 is entered to determine if preset time is reached? It returns to steps 305 and 306 to record the movie code of the network movie, the time label on the played picture of the network movie, the marking area and the data related to the advertisement activity to the movie code field, the time label field, the marking area field and the advertisement data field in the activity data base again as soon as it is determined that the preset time is reached in step 308.

Wherein, it is preferable that the preset time is 1 second, that is, when the user finds an advertisement scene in step 302 and instructs to pause the played movie to set up data related to the advertisement scene in the activity data base, the data related to the advertisement scene which is intended to be set up is keyed in as the activity data, and then it is instructed to play the movie continuously. Location and size of the marking area indicated on the picture can be adjusted along with scene change shown on the picture during the movie playing. The procedure is performed in a way of each activity record being automatically done with an interval of 1 second for the user able to check the data related to the scene during watching the movie.

Besides, when it is judged in step 307 that the user has instructed to pause the played movie again, it means that it is intended to stop setting up the activity data related to the found scene, and step 309 is entered to wait the user to instruct the movie to continue playing and repeating the preceding procedure for setting up the activity data till the movie playing is end.

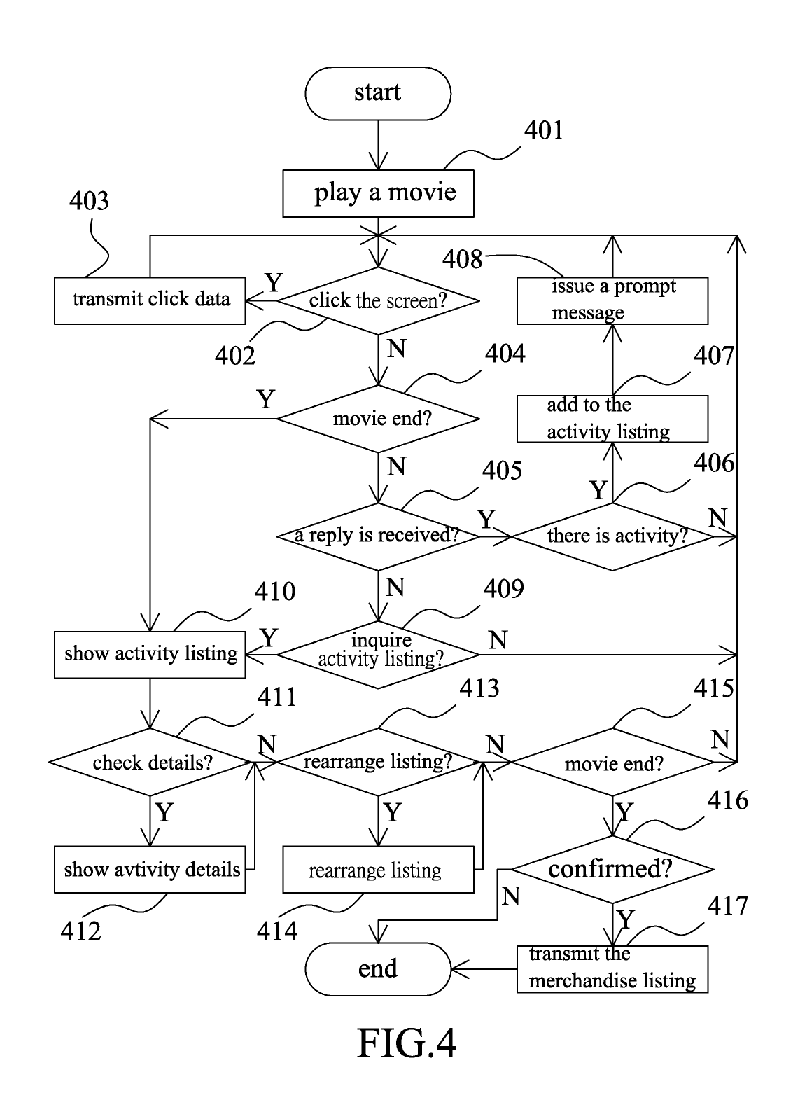

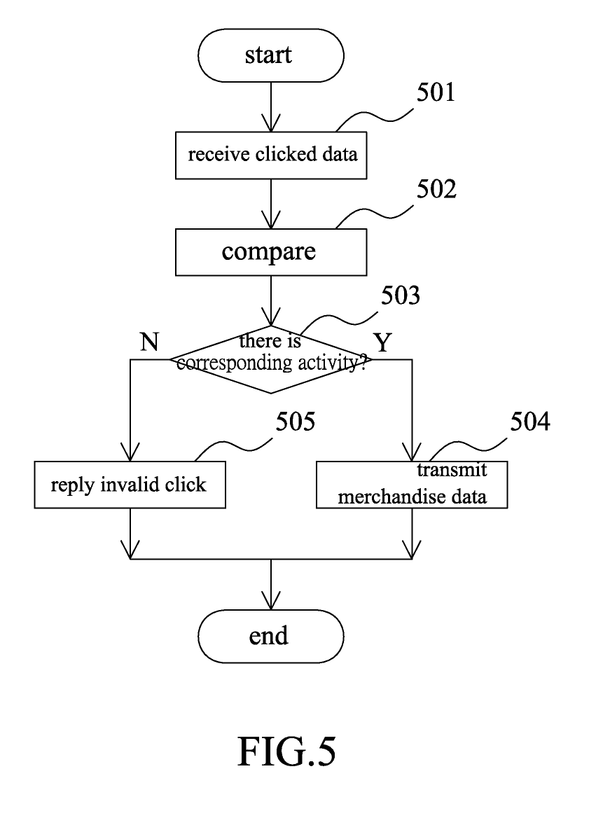

Referring to FIGS. 4 and 5, service procedure of the movie player and the network server provided in the network movie instant merchandise purchase system shown in FIG. 1 are illustrated. In step 401, the movie player plays a network movie chosen by the user, and step 402, 404, 405, and 409 are performed when the movie is playing so as to judge if the user clicks the merchandise shown on the played picture of the network movie on the screen, if the movie plays to the end, if a reply from the network server 11 is received, and if the user instructs to inquire an activity listing.

When it is determined in step 402 that the user has clicked the merchandise shown on the played picture of the network movie on the screen, step 403 is entered to transmit the movie code, the time label and clicked coordinates to the network sever 11 and to be received by the network server 11 in step 501. In step 502, the movie code, time label and clicked coordinates received by the network server 11 are compared with the activity data in the activity data base; then, in step 503, results after comparison are judged if there is any corresponding activity?

In steps 502, and step 503, when there is activity data including a marking area with the clicked coordinates at a preset time interval such as 0.6 second before and after the time label of the network movie which is directed by the received movie code, step 504 is entered to transmit the merchandise data in the merchandise data field of the activity data to the movie player for the movie player capable of including this activity data in the activity listing. On the contrary, step 505 is entered to reply to the movie player that the click done by the user is invalid click.

Meanwhile, in step 405, the movie player receives the reply of the network server 11, and step 406 is entered to judge if the reply contains the activity data? When it is determined that there is the activity data, step 407 is entered to add the received activity data to the activity listing, and step 408 is entered to issue a prompt message such as a small icon to notify the user that the clicked merchandise or advertisement has been included in the activity listing.

Furthermore, in step 404, when movie player determines the movie is done, or, in step 409, determines that the user instructs to inquire the activity listing, step 410 is entered to show the activity data in the activity listing such as the merchandise name, the merchandise thumbnail URL, and the merchandise description URL or the advertisement data URL on the picture for the user able to link the URL to check the activity details.

In the process of inquiring the activity listing, the movie player judges if the user checks the activity details via the URL, if the activity listing is rearranged, or if the movie is end via steps 411, 413 and 415 respectively? When the user chooses to check the activity details, step 412 is entered to show the activity detail picture which links with the URL to the user; when the user chooses to rearrange the activity listing, step 414 is entered to perform listing rearrangement such as deleting the activity data. When the movie is end, step 416 is entered to allow the user to choose if purchase is confirmed? When confirmation of the purchase is chosen, step 417 is entered to transmit the merchandise listing to such as the network service server to perform network purchase service procedure such as subsequent payment confirmation and merchandise delivery.

While the invention has been described with referencing to the preferred embodiments thereof, it is to be understood that modifications or variations may be easily made without departing from the spirit of this invention, which is defined by the appended claims.

What is claimed is:

1. A network movie instant merchandise purchase system, which is suitable for a user to instantly purchase merchandise shown on a network movie during watching the network movie, comprising:
a network server having an activity data base which contains multiple activity data, each of the activity data including a movie code field, a time label field, a marking area field, and a merchandise data field, the movie code field having a movie code directing to said network movie, the time label field having a time label directing to an image picture on a timeline provided by the network movie, the marking area field having a marking area standing for a merchandise location shown on the image picture directed by the time label of the network movie, and the merchandise data field being data related to the merchandise shown in the marking area of the image picture directed by the time label of the network movie; and
a movie player being connected to the network server via a network to play the network movie;
wherein, when the user clicks the merchandise shown on a played picture of the network movie, the movie player transmits a movie code, a time label and clicked coordinates corresponding to the played picture to the network server available for the network server to compare with the activity data of the activity data base, and when the activity data at a preset time interval before and after the time label of the network movie directed by the movie code contain a marking area with the clicked coordinates, merchandise data in the merchandise data field of the activity data is included in an activity listing.

2. The network movie instant merchandise purchase system as defined in claim 1, wherein said network server transmits the merchandise data to the movie player so as to allow the movie player to include the merchandise data in the activity listing.

3. The network movie instant merchandise purchase system as defined in claim 1, wherein part of the activity data contained in the activity data base of the network server includes the movie code field, the time label field, the marking area field, and an advertisement data field; the advertisement data field is advertisement data related to a scene shown on the marking area of the image picture directed by the time label of the network movie.

4. The network movie instant merchandise purchase system as defined in claim 1, wherein the preset time interval is 0.6 second before and after the time label of the network movie directed by the movie code.

5. A network movie instant merchandise purchase method, which is suitable for a network server to provide a user to instantly purchase merchandise shown on a network movie during watching the network movie, said network server having an activity data base which contains multiple activity data, each of the activity data including a movie code field, a time label field, a marking area field, and a merchandise data field, the movie code field having a movie code directing to said network movie, the time label field having a time label directing to an image picture on a timeline provided by the network movie, the marking area field having a marking area standing for a merchandise location shown on the image picture directed by the time label of the network movie, and the merchandise data field being data related to the merchandise shown in the marking area of the image picture directed by the time label of the network movie, comprising following steps:
receiving a movie code, a time label, and clicked coordinates corresponding to said played picture at the time of the user clicking the merchandise shown on a played picture of the network movie;
comparing the movie code, time label and clicked coordinates corresponding to the played picture to the activity data of the activity data base;
transmitting a merchandise data in the merchandise data field of the activity data to be included in an activity listing at the time of the activity data at a preset time interval before and after the time label of the network movie directed by the movie code having the marking area which contains the clicked coordinates.

6. The network movie instant merchandise purchase method as defined in claim 5 further comprising a step of available for the user to inquire or rearrange said activity listing.

7. The network movie instant merchandise purchase method as defined in claim 5, wherein part of the activity data contained in the activity data base of the network server includes a movie code field, a time label field, a marking area field, and an advertisement data field; the advertisement data field is advertisement data related to a scene shown on the marking area of the image picture directed by the time label of the network movie.

8. The network movie instant merchandise purchase method as defined in claim 5, wherein the preset time interval is 0.6 second before and after the time label of the network movie directed by the movie code.

9. A method for setting up merchandises in a network movie, which is suitable for setting up an activity data base required by the network movie instant merchandise purchase, the activity data base containing multiple activity data, each of the activity data including a movie code field, a time label field, a marking area field, and a merchandise data field, comprising following steps:
capturing an image on a played picture of the network movie;
capturing a merchandise image;
comparing if the merchandise image is on the played picture;
recording the movie code of the network movie, the time label at the played picture in the network movie, marking area of the merchandise on the played picture, and the data related to the merchandise represented by the merchandise image to the movie code field, the time label field, the marking area field, and the merchandise data field of the activity data base respectively at the time of the merchandise image being on the captured played picture.

10. The method for setting up merchandises in a network movie as defined in claim 9, wherein the merchandise image is determined to be on the captured played picture if at least part of the features of the merchandise image is resided in the played picture with a proportional value greater than a default proportional value.

11. The method for setting up merchandises in a network movie as defined in claim 10, wherein the default proportional value is 25%.

12. The method for setting up merchandises in a network movie as defined in claim 9, wherein the marking area is a rectangular marking block formed by upper left coordinates, horizontal width and vertical height at the position of the captured image of the merchandise shown on the played picture.

13. The method for setting up merchandises in a network movie as defined in claim 9, wherein data related to the merchandise represented by the image of the merchandise includes merchandise name, merchandise thumbnail URL, and merchandise descriptive URL.

14. A method for setting up advertisement in a network movie, which is suitable for setting up an activity data base in accordance with operation of a user, the activity data base containing multiple activity data, each of the activity data including a movie code field, a time label field, a marking area field, and a advertisement data field, comprising following steps:
playing the network movie;
capturing an advertisement activity data which is assigned by the user at the time of receiving the user requesting to pause the movie play and choosing to continue to play;
repeating following steps at the time of not receiving the user requesting to pause the movie play:
capturing the time label at which the played picture of said network movie is and a marking area assigned by the user;
recording the movie code of said network movie, the time label at which the played picture of said network movie is, the marking area, and the data related to the advertisement activity to the movie code field, the time label field, the marking area field and the advertisement data field.

15. The method for setting up advertisement in a network movie as defined in claim 14, wherein said preset time is 1 second.
